(19) United States
(12) Patent Application Publication
(10) Pub. No.: US 2011/0296953 A1
(43) Pub. Date: Dec. 8, 2011

(54) Method of Co-Firing Raw Glycerin in a Melting Furnace

(75) Inventors: David G. Schalles, Jefferson Hills, PA (US); James N. Checkeye, Butler, PA (US); Robert F. Green, Bethel Park, PA (US); Jason D. Sweeney, South Park, PA (US)

(73) Assignee: BLOOM ENGINEERING COMPANY, INC., Pittsburgh, PA (US)

(21) Appl. No.: 13/117,339

(22) Filed: May 27, 2011

Related U.S. Application Data
(60) Provisional application No. 61/352,605, filed on Jun. 8, 2010.

(51) Int. Cl. C22B 21/00; F23G 7/00; C03B 5/16

(52) U.S. Cl. 75/686; 65/134.3; 110/342

(57) ABSTRACT

A method of firing a melting furnace to which flux or fining additions are made, comprising supplying the burner systems with a fuel mixture containing at least 10% glycerin wherein the glycerin contains sodium chloride (NaCl), potassium chloride (KCl), or a combination thereof. The glycerin can advantageously be raw glycerin, a by-product of biodiesel production. It can be co-fired with natural gas or fuel oil or fired alone in traditional combustion burner systems. Alternatively, the glycerin may be supplied with NaCl and KCl in the same proportion as the flux used in the melting furnace. Significant fuel cost savings and potential flux cost savings may be realized using this method. The method is applicable to furnaces used in the production of aluminum or glass having similar burner systems and utilizing NaCl and/or KCl additions as part of the melting process.

### CROSS REFERENCE TO RELATED APPLICATIONS

The present application claims priority to U.S. Provisional Patent Application No. 61/352,605 filed Jun. 8, 2010 entitled “Method of Co-firing Raw Glycerin in a Melting Furnace”, the entire disclosure of which is herein incorporated by reference.

### BACKGROUND OF THE INVENTION

1. Field of the Invention

The present invention is generally directed to a method of firing a melting furnace and more particularly to supplying such burner systems with a fuel mixture containing glycerin, which is a by-product of biodiesel production.

2. Description of Related Art

Biodiesel fuel production is increasing exponentially around the world. The biodiesel production process requires the addition of catalysts which, in many cases, contain sodium or potassium. Glycerin (also known as glycerine and glycerol) is the largest byproduct of biodiesel production with about 100 kg of glycerin produced for every metric ton of biodiesel produced. However, due to the use of the sodium or potassium containing catalysts, the glycerin contains sodium chloride (NaCl) or potassium chloride (KCl). This contamination makes the glycerin by-product, called raw or crude glycerin, unsuitable for many of the traditional uses for glycerin, as well as many possible new uses, such as a fuel for firing melting furnaces. Most direct fired industrial furnace operations cannot tolerate the introduction of NaCl or KCl into the furnace, and radiant tube-fired furnaces cannot tolerate the build-up of these salts in the radiant tubes and the exhaust systems. In addition, purification of the raw glycerin appears to be cost prohibitive for use as a fuel. As such, there is an abundant supply of raw glycerin available.

In the secondary aluminum production industry, scrap aluminum is melted in reverberatory furnaces using burner systems where the flames and combustion products enter the furnace and may contact the melt. Therefore, any fuels that are used in the burner systems must not contain ingredients that, when combusted, would contaminate the furnace or the molten metal. Thus, these combustion burner systems are fired using traditional fuels such as natural gas and fuel oil.

During melting, because aluminum is so chemically active, a film of aluminum oxide quickly forms on the surface of the molten aluminum whenever it is exposed to air. Therefore, without protection, a great deal of aluminum oxide can be generated during the melting process due to mixing, stirring, and agitation of the molten metal. Trapped aluminum oxide in the molten metal during casting results in defects in the cast product which damage the mechanical properties of the finished aluminum product.

Fluxes are added to the melting furnace to minimize and remove aluminum oxide formed during the melting process. Drossing fluxes work by dewetting of the oxide/melt interface to separate the oxides from the metal and float them to the surface of the bath where they can be easily separated from the molten aluminum prior to or during tapping of the furnace. Cover fluxes are also used to provide a cover on the surface of the molten metal to prevent oxidation by keeping it from contacting the air. Key components of these fluxes are NaCl and KCl. The chloride ions also bind to other impurities such as magnesium to allow removal of MgCl₂ in the dross layer.

Similarly, glass melting processes use similar burners and fining agents that contain NaCl and/or KCl to remove bubbles from the glass.

There exists a need to utilize alternative fuels in industrial heating processes to realize significant fuel cost savings. It would also be advantageous to reduce flux and fining agent costs in secondary aluminum and glass melting processes. The object of the invention is therefore to provide a method of firing a melting furnace using glycerin containing NaCl and/or KCl, thereby lowering fuel costs and simultaneously providing useful flux or fining agent components to the aluminum or glass melting process.

### SUMMARY OF THE INVENTION

The present invention is directed to a method of firing a melting furnace to which flux or fining agent additions are made, comprising supplying the burner system with a fuel mixture containing glycerin wherein the glycerin contains sodium chloride (NaCl), potassium chloride (KCl), or a combination thereof. The glycerin can advantageously be raw glycerin, a by-product of biodiesel production. It can be co-fired with natural gas or fuel oil or fired alone in traditional combustion burner systems. Alternatively, the glycerin may be supplied with NaCl and KCl in the same proportion as the flux used in the melting furnace.

The method is applicable to furnaces used in the production of aluminum, alloyed aluminum, or glass having similar burner systems and utilizing NaCl and/or KCl additions as part of the melting process.

### DETAILED DESCRIPTION OF THE INVENTION

Raw glycerin, sometimes called crude glycerin, is a by-product of biodiesel production. It is a combination of methanol, water, free fatty acids, and inorganic salts. The most common inorganic salts are sodium chloride (NaCl) and potassium chloride (KCl). The inventors have found that raw glycerin from biodiesel production can be effectively co-fired with fuel oil or natural gas or fired as the sole fuel (100%) using conventional direct fire fuel oil or natural gas burners such as those described in U.S. Pat. Nos. 3,180,394 and 6,471,508, incorporated herein by reference. When co-firing the raw glycerin with natural gas or fuel oil, the glycerin may be present in an amount of at least about 10%. The combustion of the glycerin is very advantageous as it provides heat to the furnace at a much lower cost than traditional fuels such as natural gas and fuel oil. Heavy-oil combustion burner systems which utilize oil pre-heating (120-220° F.) prior to combustion to lower the viscosity of the fuel, such as Bloom Engineering 1800-series burner systems, are particularly well suited for burning a fuel mixture containing glycerin which can start to solidify below about 70-80° F. A preheat temperature of 100-120° F. may also be utilized. Alternatively, oxygen combustion could be used to fire the glycerin or glycerin-containing fuel. Oxy-firing is common in glass furnaces as well as secondary aluminum melting furnaces that use very dirty aluminum scrap where reduced flue gas volume is desirable for efficiency and environmental reasons. The fuel cost savings from the use of glycerin could help to offset the expense of the oxygen. These burner systems also advantageously combust the fuel at a high enough temperature (1400-1500° F.) to avoid the formation of glycerol burned acrolein which is toxic and can form when glycerin is combusted at low temperatures (<1000° F.).

However, for most burner systems in actual production settings, the NaCl or KCl in the raw glycerin will be troublesome. When fired as a fuel, the products of combustion of the raw glycerin include ash which has a high content of whichever salt, NaCl or KCl, is present in the raw glycerin. In the case of direct fired furnaces where the contents of the furnace are directly exposed to the flame and products of combustion, the NaCl or KCl may be an undesirable contaminant for the product being produced. In the case of radiant furnaces where only the heat is transferred to the process and the flame and products of combustion are contained within a radiant tube or some other containing device, the NaCl and KCl may build up on the walls of the radiant tube or in the exhaust gas pipes. NaCl and KCl can be very corrosive and could lead to deterioration of equipment in either case. While flue gas cleaning, such as wet scrubbing or using a baghouse, could be utilized to remove the NaCl or KCl from the exhaust gases, significant costs would be incurred negating any savings achieved from the substitution of the raw glycerin for fuel oil or natural gas.

However, the inventors have determined that in the case of secondary aluminum melting furnaces which are directly fired, the raw glycerin may be advantageously used as a fuel because the melting process already uses NaCl and KCl in the flux.

Secondary aluminum melting furnaces or reverberatory furnaces are direct-fired, meaning that flame from the combustion of natural gas or fuel oil in the burner system is directed into the furnace. This means that any products of combustion or impurities present in the flame are introduced into the furnace and thus can be introduced to the metal.

Aluminum is very susceptible to oxidation especially at high temperatures. Therefore, during melting, if the molten aluminum is exposed to oxygen in the atmosphere, it will form an oxide skin. As the molten aluminum is agitated in the furnace, this oxide skin is formed many times as new metal is exposed to the air. It is also pulled into the molten aluminum where it will remain during casting, resulting in defects in the cast ingots. These defects have a detrimental effect on the mechanical properties of the finished aluminum product.

To avoid aluminum oxide defects from melting, fluxes are used in the furnace. Fluxes are chemicals that either assist in removal of the aluminum oxide and the removal of impurities such as magnesium (drossing fluxes), or cover the surface of the molten aluminum to reduce oxide formation (cover fluxes). Primary constituents of these fluxes are sodium chloride (NaCl) and potassium chloride (KCl).

Therefore, when raw glycerin is co-fired or fired alone in the burner system of a secondary aluminum melting furnace that uses a flux, any NaCl and/or KCl introduced into the furnace would not be a contaminant since they are commonly used ingredients of the melting process. The addition of additional chloride to the melt from the NaCl or KCl may even reduce the amount of flux additions required to be added manually to the furnace.

Raw glycerin may contain from 1% up to about 7% NaCl or KCl by weight. As the mass balance for a typical secondary aluminum melting furnace fired using raw glycerin alone or co-fired with natural gas shown in Table 1 illustrates, raw glycerin would only supply a small amount of additional NaCl or KCl to the furnace but would result in large energy cost savings.

The amount of NaCl or KCl as a fraction of the flux required may be higher for other similar furnaces that do not melt as much dirty scrap as the furnace used for these calculations. However, it can be seen that the amount of additional NaCl or KCl supplied to the melt would not be excessive or exceed the process needs.

TABLE 1
Material Balance for a Typical Secondary
Aluminum Melting Furnace

| Annual aluminum throughput | 71,357 | MT/year |
|---|---|---|
| Annual flux addition | 4,338 | MT/year |
| Approximate total annual fuel consumption | 283,216 | mmBTU/year |
| Higher Heating Value (HHV)/Heat of | 12,500 | BTU/lb |
| Combustion of glycerin | | |
| Annual glycerin used - 100% glycerin | 10,275 | MT/year |
| Salt available at 7% by weight in glycerin | 719 | MT/year |
| Additional salt (NaCl, KCl, or a combination) | 16.6% | |
| supplied as a fraction of flux requirement | | |
| Fuel cost savings (gas cost $6.00/BTU - | $1.27 | million |
| glycerin cost $1.50/BTU × total BTU/yr) | | |
| Annual glycerin used - 10% glycerin | 1,028 | MT/year |
| Salt available at 7% by weight in glycerin | 72 | MT/year |

| | |
|---|---|
| Additional salt (NaCl, KCl, or a combination) | 1.7% |
| supplied as a fraction of flux requirement | |
| Fuel cost savings (gas cost $6.00/BTU - | $127,000 |
| glycerin cost $1.50/BTU × total BTU/yr) | |

Alternatively, the burner systems may be fired using a combination of glycerin containing NaCl and glycerin containing KCl in the same proportions as the NaCl and KCl in the aluminum melting flux. In this way, two advantages are realized. First, fuel costs are reduced, since raw glycerin is significantly less expensive than natural gas or fuel oil. Second, fluxing costs can be decreased because the addition of the NaCl and KCl from the combustion of the raw glycerin may replace a portion of the flux and reduce the amount of flux additions that are required. As the mass balance for a typical secondary aluminum melting furnace fired using raw glycerin alone or co-fired with natural gas shown in Table 1 illustrates, in the case where glycerin containing both NaCl and KCl at a 7% level is used, as much as a 16.6% reduction in flux usage and significant fuel cost savings could be realized. In addition, some reduction in labor would be realized, as the flux is generally added to the furnace manually.

The appropriate amount of glycerin to be used can be determined according to the amount of fuel cost savings desired and/or the amount of additional NaCl or KCl that may be tolerated by the operation based on flux addition requirements as well as air particulate emission requirements.

While the discussion has focused on secondary aluminum melting furnaces, furnaces used in the production of glass have similar burner systems and use NaCl and/or KCl fining agent additions to remove bubbles from the glass. Therefore, the raw glycerin could also be used as a fuel for glass furnaces where fining agent additions containing NaCl and/or KCl are made.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. A method of firing a furnace to which flux or fining agent additions are made comprising: supplying a burner system of the furnace with a fuel containing glycerin wherein the glycerin contains sodium chloride, potassium chloride, or a combination thereof.

2. The method according to claim 1, wherein the fuel contains at least about 10% glycerin.

3. The method according to claim 1, wherein the fuel contains 10-100% glycerin.

4. The method according to claim 1, wherein the glycerin is raw glycerin that is a by-product of biodiesel production.

5. The method according to claim 1, wherein the amount of glycerin in the fuel is determined by the amount of sodium chloride, potassium chloride, or a combination thereof that can be tolerated by the melting process.

6. The method according to claim 1, wherein the fuel contains natural gas or fuel oil.

7. The method according to claim 1, wherein the glycerin contains at least 1% by weight sodium chloride, potassium chloride, or a combination thereof.

8. The method according to claim 1, wherein the burner system is a heavy-oil combustion system that heats the fuel prior to combustion to lower the viscosity.

9. The method according to claim 1, wherein the firing uses oxygen injection to improve combustion.

10. The method according to claim 1, wherein the glycerin contains sodium chloride, potassium chloride, or a combination thereof in the same proportions as the flux or fining agent.

11. The method according to claim 10, wherein enough sodium chloride, potassium chloride, or a combination thereof is supplied by the glycerin to replace at least 1.7% of the flux used in the melting furnace.

12. The method according to claim 1, wherein the material being melted is aluminum or alloyed aluminum.

13. The method according to claim 1, wherein the material being melted is glass.
